(19) United States
(12) Patent Application Publication
(10) Pub. No.: US 2025/0026301 A1
(43) Pub. Date: Jan. 23, 2025

(54) INFLATION DEVICES FOR INFLATING OBJECTS WITH MULTIPLE SOURCES OF AIR

(71) Applicant: Sunrise MFG, Inc., Rancho Cordova, CA (US)

(72) Inventors: Matthew Watson SEWELL, El Dorado Hills, CA (US); Dawn Marie BEERMANN, Fair Oaks, CA (US); Thomas Ryan HICKEL, Fair Oaks, CA (US); Matthew Neil ALLEN, Gig Harbor, WA (US); Christopher Prescott SHAW, Cape Town (ZA); Ryan Douglas FOWLER, Cape Town (ZA); Byron Alexander QUALLY, Cape Town (ZA)

(21) Appl. No.: 18/778,353

(22) Filed: Jul. 19, 2024

Related U.S. Application Data
(60) Provisional application No. 63/527,804, filed on Jul. 19, 2023.

(51) Int. Cl. B60R 21/26

(52) U.S. Cl. CPC B60R 21/26; B60R 2021/26094

(57) ABSTRACT

An inflation device that draws air in from two sources, such as air compressor and ambient air, can inflate an object (e.g., air bag). When a valve is opened, airflow from the air compressor is provided from the inflation device to the object. The airflow may cause airflow from an additional source (e.g., ambient air) into the inflation device. Additionally, a button used to control the valve is also used to initiate power to an assembly that includes pressure sensor (used to measure pressure of the airflow) and a display (used to present the current pressure as measured by the pressure sensor). The inflation device can automatically power down at a predetermined time after the button is released.

### CROSS REFERENCE TO RELATED APPLICATION(S)

This application claims the benefit of U.S. Provisional Application No. 63/527,804, entitled “INFLATION DEVICES FOR INFLATING OBJECTS WITH MULTIPLE SOURCES OF AIR,” filed Jul. 19, 2023, the entirety of which is incorporated herein by reference.

### TECHNICAL FIELD

This application is directed to an inflation devices, and more particularly, to inflation devices that can draw air in from multiple air sources.

### BACKGROUND

Inflation devices can be used to inflate objects with air from an air compressor. Inflation devices may include electrical components that can be turned on and off by an on/off switch and subsequently can be operated by a separate button.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of an inflation device, in accordance with aspects of the present disclosure.

FIG. 2 illustrates an exploded view of an inflation device, in accordance with aspects of the present disclosure.

FIG. 3 illustrates a perspective view of an example of a regulating device, in accordance with aspects of the present disclosure.

FIG. 4 illustrates a cross sectional view of an inflation devices, showing several openings in the regulating device, in accordance with aspects of the present disclosure.

FIG. 5 and FIG. 6 illustrate exemplary airflow paths through an inflation device, in accordance with aspects of the present disclosure.

FIG. 7 and FIG. 8 illustrate exemplary movement of a button of an inflation device, and the resultant action of other components of the inflation device, in accordance with aspects of the present disclosure.

FIG. 9 illustrates a top view of an inflation device, in accordance with aspects of the present disclosure.

FIG. 10 illustrates a bottom view of an inflation device, in accordance with aspects of the present disclosure.

FIG. 11 illustrates an alternate side view of an inflation device, in accordance with aspects of the present disclosure.

FIG. 12 illustrates a perspective view of a flap, in accordance with aspects of the present disclosure.

FIG. 13 illustrates a schematic diagram of an inflation device, in accordance with aspects of the present disclosure.

FIG. 14 illustrates a flowchart showing a method for inflating an object, in accordance with aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to inflation devices used to inflate, or fill, objects such as air bags (as a non-limiting example) with air. Inflation devices described herein may include an inlet used to connect to an air source, such as an air compressor. Additionally, inflation devices described herein may include one or more additional inlets. The additional inlet(s) can also draw air (e.g., ambient air) in while the (initial) inlet receives compressed air (e.g., high speed compressed air). Beneficially, objects being inflated can receive air from multiple air sources, thus decreasing the time required to inflate the object. Moreover, ambient air is generally cost effective as compared to compressed air, and the cost associated with inflating the object may be reduced.

To regulate airflow from the air compressor, inflation devices described herein may include a valve. However, the remaining inlet(s) may be regulated by valves that function as doors that open or close based upon current air pressure within the inflation device. Put another way, the valves that permit ambient air require no external power for operation. In order to open the valve to these inlets, the airflow from the air compressor passes through the inflation device. By reducing the volume through a channel in which the compressed air passes, the compressed air may pass through the inflation device at a higher rate of speed through the reduced area, thus drawing ambient air into the inflation device and to the object being inflated. However, when the object becomes inflated, at least some of the airflow can return from the object into the inflation device as backflow, creating a back pressure that causes the valves (e.g., doors) to shut. Generally, this may occur at or near the end of an inflation sequence of the object.

Inflation devices described herein may include a sensor designed to monitor and measure pressure (e.g., air pressure) of an object being inflated by the inflation device. Additionally, inflation devices described herein may include a display that presents, as visual information, a current pressure as measured by the sensor. In order to initiate operation, inflation devices described herein may include a button that can be gripped and actuated by a user. By actuating the button, a switch can also be actuated (e.g., the switch is closed), which in turn causes a power supply (e.g., batteries) to provide power to the display and the sensor. Further, when the inlet is connected to air compressor, actuation of the button provides a startup sequence for the components that require power (e.g., display and sensor), thus illuminating the display and activating the sensor. Moreover, actuation of the button further causes the valve (regulating the compressed air) to open. Beneficially, additional buttons (e.g., separate on/off switches) are not required, thus simplifying operation of the inflation device. Also, when the button is released and the switch is no longer actuated (e.g., the switch opens), a power down sequence may occur that automatically powers down the components that require power after a predetermined time has passed.

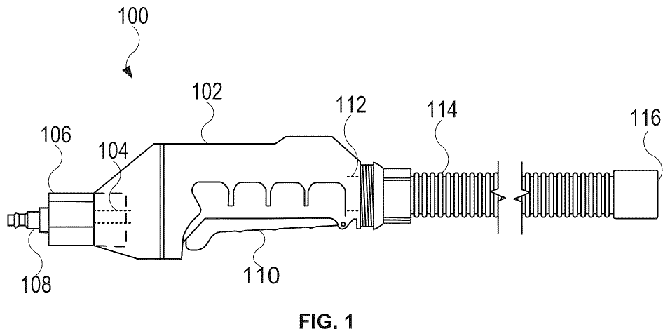

These and other embodiments are discussed below with reference to FIGS. 1-13. However, those skilled in the art will readily appreciate that the detailed description given herein with respect to these Figures is for explanatory purposes only and should not be construed as limiting.

According to some embodiments, for example as shown in FIG. 1, an inflation device 100 is shown. The inflation device 100 may be used to inflate (e.g., provide pressurized air to) an object (not shown in FIG. 1). Exemplary objects shown and/or described herein may include inflatable dunnage bags that expand and fill voids between cargo. As shown, the inflation device 100 includes a body 102. The body 102 may include a rigid polymer (e.g., plastic) construct that integrates several components of the inflation device 100. The inflation device 100 may further include inlets 104 that provides path for the inflation device 100 to receive air into the inflation device 100. As shown, the inlets 104 include a pair of inlets. The inlets 104 may provide one of several inlets for the inflation device 100. This will be further shown and described below.

The inflation device 100 may further include a valve 106 used to regulate air into the inflation device 100 through the inlets 104. In one or more implementations, the valve 106 is a mechanically controlled valve, as a non-limiting example. In order to receive compressed air, the inflation device 100 may include a connector 108 coupled to the valve 106. Accordingly, in some examples, the connector 108 is a compressed air coupling. Also, the connector 108 may be removable from the inflation device 100 (including removable from the valve 106), allowing a different connector to be connected to the inflation device 100 (including the valve 106) based on the desired air source.

In order to operate the valve 106, the inflation device 100 may include a button 110, or trigger. The button 110 can be actuated by moving the button 110 relative to, and toward, the body 102. When no force is applied to the button 110, the valve 106 may close. However, when a force is applied (by, for example, a user of the inflation device 100) to actuate the button 110 toward the body 102, the valve 106 opens and allows air in through the inlets 104 via the connector 108. When the force is removed from the button 110 (causing the button 110 to return to its prior state), the valve 106 closes.

The inflation device 100 may further include an outlet 112 through which air received by the inlets (e.g., inlets 104) exits the inflation device 100. Also, the inflation device 100 may include a hose 114 and a connector 116 coupled to an end of the hose 114. When the connector 116 is connected to an object (e.g., air bag), the hose 114 may provide a conduit for air exiting the outlet 112 into the object. Similar to the connector 108, the hose 114 may be removed from the inflation device 100, at or near the outlet 112, and a new conduit may be provided based on factors such as desired length, desired connection, type of object, or a combination thereof, as non-limiting examples.

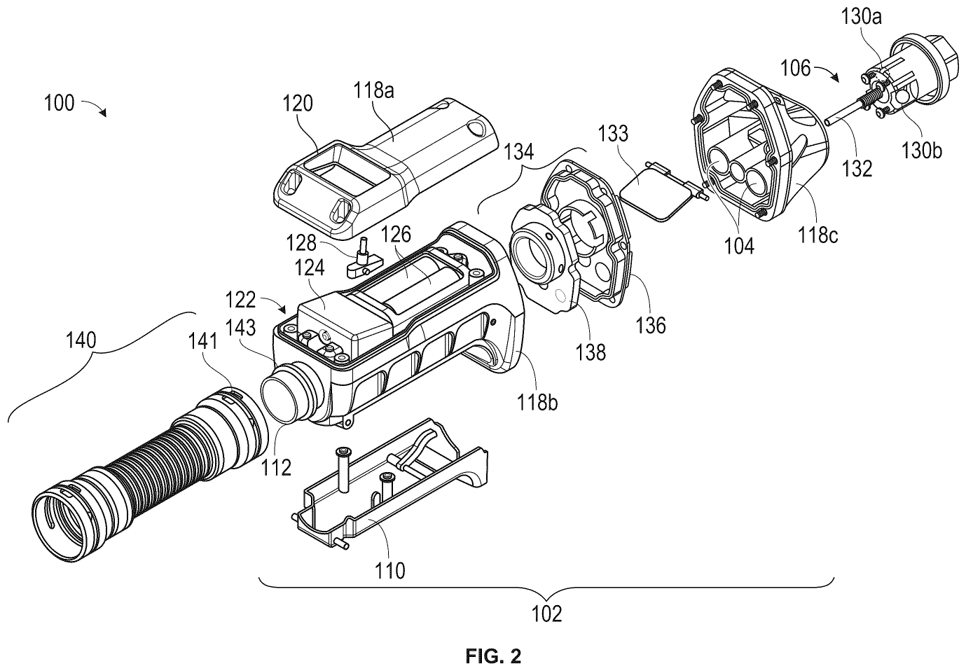

Referring to FIG. 2, an exploded view of the inflation device 100 is shown. The body 102 may include several components. For example, the body 102 may include a housing part 118a. Based on its relative location, the housing part 118a may be referred to as an upper housing part or a top housing part. The housing part 118a may include an opening 120.

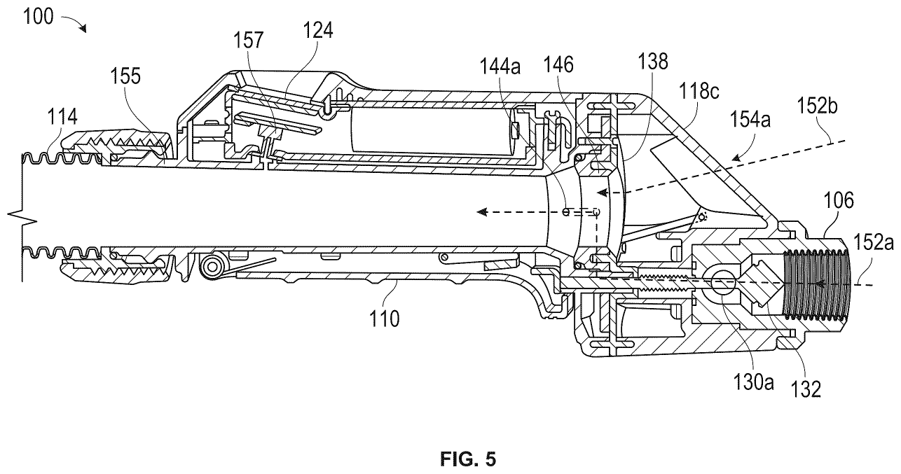

The body 102 may further include a housing part 118b. Based on its relative location, the housing part 118b may be referred to as a lower part. The housing part 118b may carry an assembly 122. In one or more implementations, the assembly 122 one or more components (discussed below). In this regard, the assembly 122 may include an integrated package of components, thus providing a sub-assembly for the inflation device 100. Beneficially, the assembly 122 may, including its components, may be removed and/or replaced based on damage to the assembly 122 and/or to update the assembly 122, as non-limiting examples. The assembly 122 may provide a variety of functions. For example, the assembly 122 may include a sensor designed to monitor and measure pressure (e.g., air pressure) in an object (not shown in FIG. 2) being inflated by the inflation device 100. In some examples, the assembly 122 includes a sensor (shown later in FIG. 5), which may include a piezoelectric sensor or a strain gauge, as non-limiting examples. In this regard, the assembly 122 can output a signal (e.g., electrical signal) corresponding to a pressure, as determined by an applied stress (e.g., mechanical stress or strain) to an element (e.g., piezoelectric sensor or a strain gauge) of the sensor of the assembly 122. In one or more implementations, the sensor measure relative internal pressure between the absolute pressure and the pressure in the object (e.g., inflatable dunnage bag). The assembly may further include a display 124 designed to present visual information. In this regard, the display 124 may present a pressure reading based on the pressure measured by the sensor of the assembly 122. In one or more implementations, a user of the inflation device 100 may adjust the units of pressure presented at the display 124. The assembly 122 may further include a power source 126. In some examples, the power source 126 takes the form of one or more batteries. Accordingly, the power source 126 may include a direct current (DC) source that provides energy (e.g., electrical energy) to operate various components of the inflation device 100, such as the components of the assembly 122, as non-limiting examples. As shown in FIG. 2, the power source 126 includes batteries. Based on the power source 126, the inflation device 100 relies upon power from an internal source rather than being plugged into an external power outlet. Beneficially, the inflation device 100 provides portability, as the inflation device 100 is not limited in mobility due to a power cord. Also, the button 110 may connect to the body 102 at the housing part 118c.

Additionally, the housing part 118b may carry an activator 128. In some examples, the activator 128 is a switch. In one or more implementations, the activator 128 includes a magnet (e.g. rare Earth magnet). The activator 128 may be enabled by depressing the button 110. When actuated by the button 110, the activator 128 may provide an input to a controller (e.g., processing circuitry, not shown) that turns on the inflation device 100, and causes the power source 126 to provide power to components of the assembly 122, such as the sensor and the display 124. When the button 110 is no longer depressed, the activator 128 returns to its prior state, and the power source 126 ceases providing power to the assembly 122. Put another way, when the button 110 is no longer depressed, the inflation device 100 is powered down. In this regard, the button 110 is not only used to control (e.g., open and close) the valve 106, but also functions as an on/off switch for the inflation device 100. Beneficially, the inflation device 100 is effectively turned off when the inflation device 100 is no longer in use. In some examples, the inflation device 100 is automatically turned off after a predetermined time (e.g. in a range of approximately 10 to 15 seconds) after the button 110 is no longer depressed. This may conserve energy stored in the power source 126. Moreover, based on the aforementioned multi-functionality of the button 110, the inflation device 100 does not require a separate, dedicated on-off switch and users of the inflation device 100 do not need to remember to turn off the inflation device 100.

The body 102 may further include a housing part 118c. Based on its relative location, the housing part 118c may be referred to as a rear housing part. As shown, the housing part 118c may include or define the inlets 104. Further, the housing part 118a may connect to the valve 106. Also, in one or more implementations, each of the housing parts 118a, 118b, and 118c includes a plastic part or other non-metal part.

In one or more implementations, the valve 106 includes a metal body (e.g., stainless steel). The valve 106 may include several opening (e.g., an opening 130a and an opening 130b) and a plunger 132. Referring to the interaction with the button 110 above, the plunger 132 may be actuated based upon actuation of the button 110, and when actuated, allows air (e.g., high pressure compressed air) through the valve 106 and the inlets 104.

The inflation device 100 may further include a flap 133, each of which is installed in the housing part 118c. In one or more implementations, the flap 133 includes a foam. During operation of the inflation device, the flap 133 may limit back flow by rotating to close openings (not shown in FIG. 2) of the housing part 118c.

The inflation device 100 may include a regulating device 134. The regulating device 134 may include a seal 136 that provides an airtight seal between the housing part 118b and the housing part 118c. Additionally, the regulating device 134 may include a chamber 138 that functions to direct air (e.g., compressed air) through several relatively smaller openings or through holes formed in the chamber 138. By forcing the compressed air through the relatively small openings, the speed of the air may increase. The increased air may cause, by a Venturi effect, ambient air through openings of the housing part 118c when the openings are uncovered by the flap 133. Beneficially, the amount of air passing through the inflation device 100 increases. In one or more implementations, the chamber 138 includes six (6) openings. However, the number of openings may vary.

Also, the inflation device 100 may include a hose assembly 140 (different from the hose 114) that couples to the body 102 (e.g., at the outlet 112). The hose assembly 140 may include various features that allow the inflation device 100 to connect to bags with different shapes/sizes and/or connectors. For example, the clip 141 (e.g., cuff clip) designed to mate with a cuff 143 on the outlet 112.

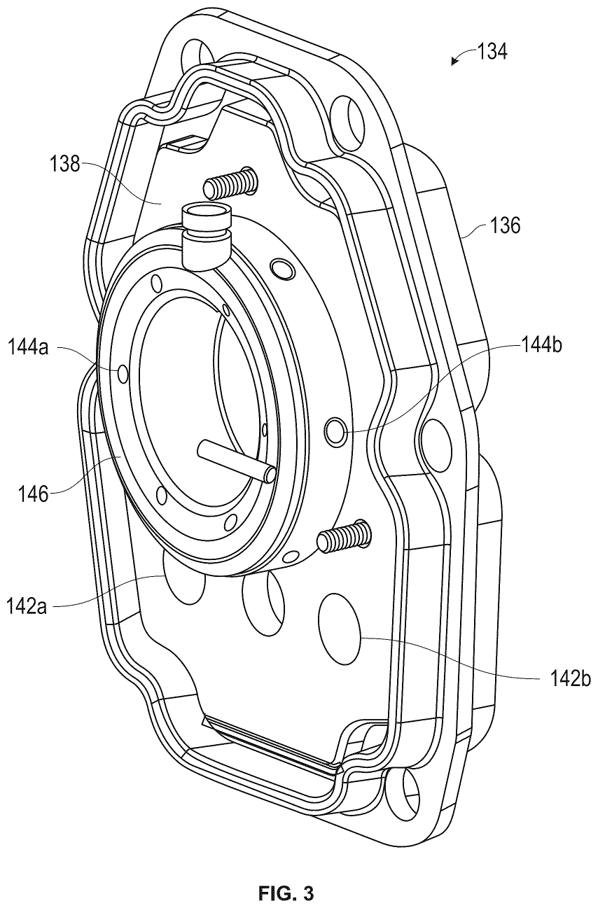

Referring to FIG. 3, the regulating device 134 is shown with the seal 136 and the chamber 138 integrated together, with the seal 136 surrounding the chamber 138. In one or more implementations, the chamber 138 includes a plastic or other non-metal material. The chamber 138 may include an injection molded part, as a non-limiting example. Also, in one more implementations, the seal 136 may include a rubber or rubber-based material, such as a thermoplastic elastomer (TPE). Further, in one more implementations, the seal 136 is over-molded to the chamber 138. Thus the respective firmness and/or rigidity of the seal 136 and the chamber 138 may differ.

The chamber 138 may several openings that serve several functions. For example, the chamber 138 may include an opening 142a and an opening 142b. Each of the openings 142a and 142b may connect to and seal a respective inlet of the inlets 104 (shown in FIG. 2). The chamber 138 may further include an opening 144a and an opening 144b, representative of several additional openings. The chamber 138 may further include an opening 146. The openings 144a and 144b may surround (e.g., circumferentially) the opening 146. As can be readily observed, the diameter of each of the openings 144a and 144b is smaller than that of the opening 146. Conversely, the diameter of the opening 146 is greater than that of each of the openings 144a and 144b.

When air (e.g., compressed air) passes through the openings 142a and 142b, the chamber 138 may direct (in conjunction with the housing part 118b, shown in FIG. 2) the air into the openings 144a and 144b. Based on the relatively small size, the openings 144a and 144b may cause the speed of the air to increase. The air passing through the openings 144a and 144b may enter the opening 146, where the air passes through the inflation device 100 (shown in FIG. 1) and through, for example, the hose 114 (shown in FIG. 1).

By integrating the seal 136 and the chamber 138 together, the regulating device 134 may be replaced reasons such as to replacing a damaged regulating device or to change the air speed (e.g., by manipulating the openings 144a and 144b).

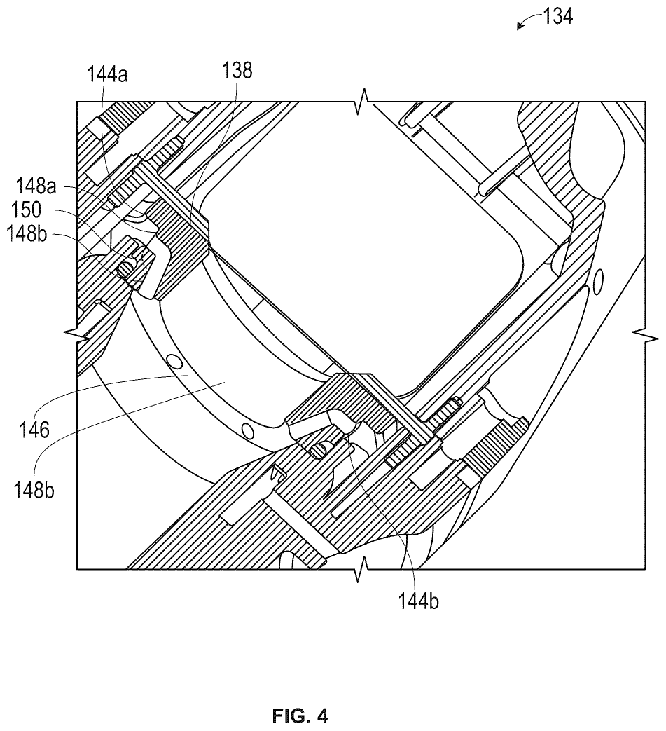

Referring to FIG. 4, a cross sectional of the inflation device 100 shows openings 144a and 144b of the chamber 138 (of the regulating device 134). The openings 144a and 144b (representative of additional openings) may include a through hole or passage that extends through the chamber 138, with the through hole having at least two portions. For example, the opening 144a may include a portion 148a and a portion 148b, with the portion 148a receiving the air (e.g., compressed air, ambient air, or a combination thereof) and the portion 148b opening to the opening 146. Further, the portion 148a and 148b may be formed at an angle 150 with respect to each other. The angle 150 may be approximately in the range of 110 to 150 degrees. In one or more implementations, the angle 150 is 140 degrees, or approximately 140 degrees.

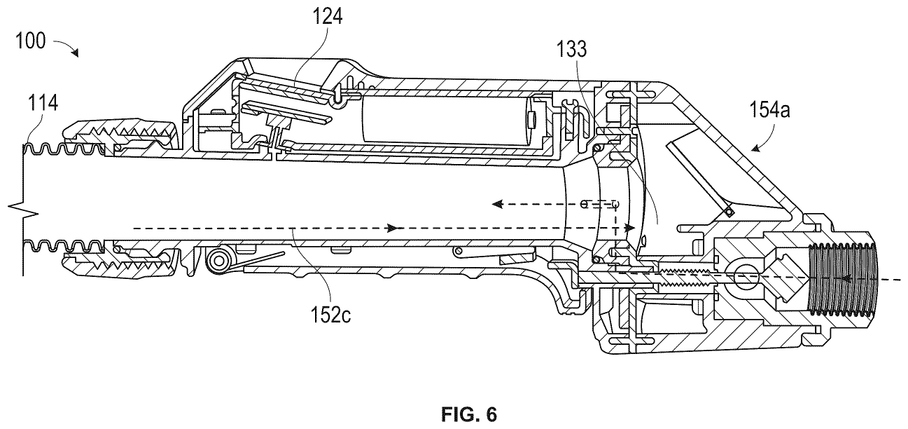

FIG. 5 and FIG. 6 illustrate exemplary airflow through the inflation device 100. Referring to FIG. 5, when the button 110 is depressed or actuated, the valve 106 is in an open position and the plunger 132 is moved, thus allowing airflow (represented by dotted lines 152a) in the form of compressed air to pass through an opening 130a (representative of an additional opening of the valve 106). The airflow then passes through the inlets 104 (shown in FIG. 2) of the housing part 118c. The chamber 138 directs the airflow through the opening 144a (representative of additional openings) of the chamber 138, where the speed of the airflow may increase, based on a Venturi effect, and draw in ambient air (represented by a dotted line 152b) through an opening 154a (representative of an additional opening of the housing part 118c). The airflow from the compressed air and the ambient air may pass through the opening 146 of the chamber 138, whether the airflow combines. The combined airflow may exit the inflation device 100 through the hose 114 (or alternatively, the hose assembly 140 shown in FIG. 2), via a channel 155 of the inflation device 100, and into an object (e.g., bag) to be inflated. The inflation device 100 further includes a sensor 157 designed to measure pressure (e.g., air pressure) through the channel 155. As shown, the channel 155 includes an opening that allows the air to flow to the sensor 157.

Referring to FIG. 6, when the object (e.g., bag) inflates, at least some of the airflow may return to the inflation device 100. For example, airflow (represented by a dotted line 152c) may pass, as backflow, from the object and into the inflation device 100 via the hose 114 (or alternatively, the hose assembly 140 shown in FIG. 2). Based on the flap 133 relative to the airflow, the airflow may cause the flap 133 to close. As a result, the airflow may leaving the object may be mitigated or prevented (e.g., blocked). Beneficially, the inflation device 100 may inflate the object in a short time interval based on the flap 133 closing to prevent the back flow from leaving the inflation device 100 into the ambient air. In one or more implementation, the flap 133 may cause an audible sound when closing and covering the opening 154a. In this regard, the flap 133 may provide feedback to the user that the object is at or near its full inflation.

Referring to FIG. 5 and FIG. 6, the display 124 is angled (e.g., angled display) such that the display 124 is generally oriented toward a user of the inflation device 100 during operation of the inflation device 100. Beneficially, the display 124 may be easier to view as compared to a horizontally positioned display.

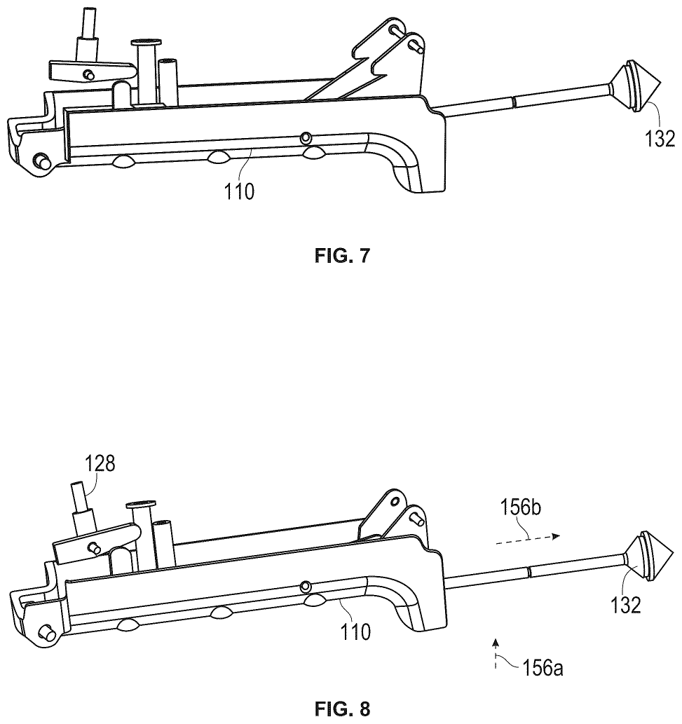

FIG. 7 and FIG. 8 illustrate movement of the button 110. Referring to FIG. 7, the button 110 is in an unactuated state. In this regard, the plunger 132 (of the valve 106 shown in FIG. 2) may close the openings 130a and 130b (shown in FIG. 2) of the valve 106, thus prevent air (e.g., compressed air) through the valve 106. Referring to FIG. 8, the button 110 is in an actuated state. In this regard, the button 110 may be depressed, causing the activator 128 to move. The activator 128 may trigger the assembly 122 (shown in FIG. 2) to activate or turn on, including the various components of the assembly 122 (e.g., sensor, display 124). Additionally, the motion of the button 110 in the direction of the arrow 156a causes a corresponding motion of the plunger 132 in the direction of the arrow 156b. Based on the movement of the plunger 132, the openings 130a and 130b (shown in FIG. 2) may permit passage of airflow (e.g., compressed air).

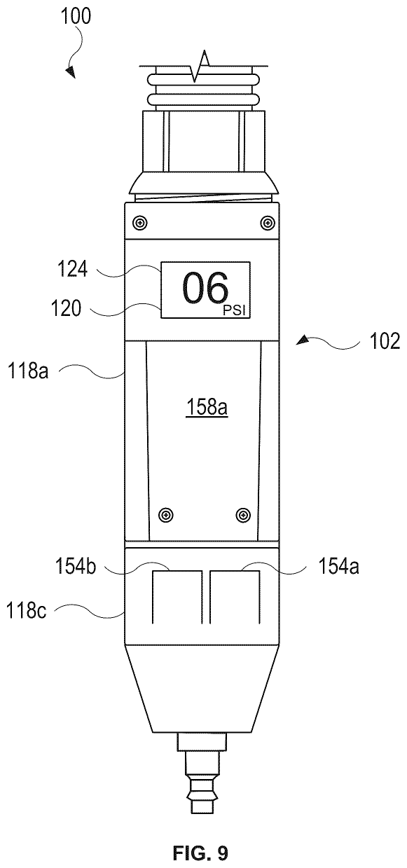

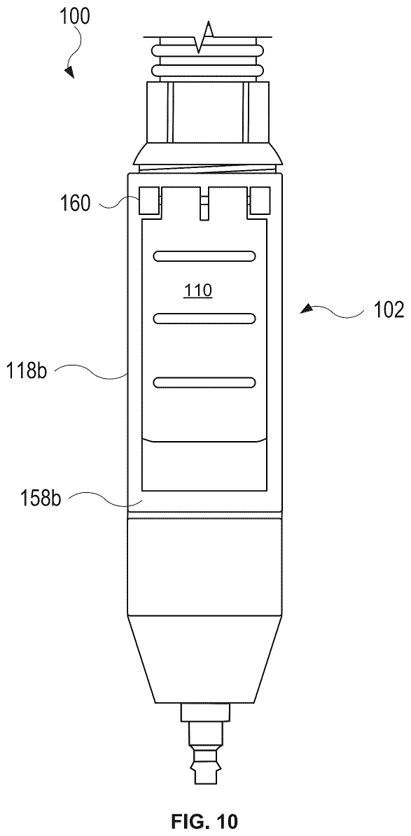

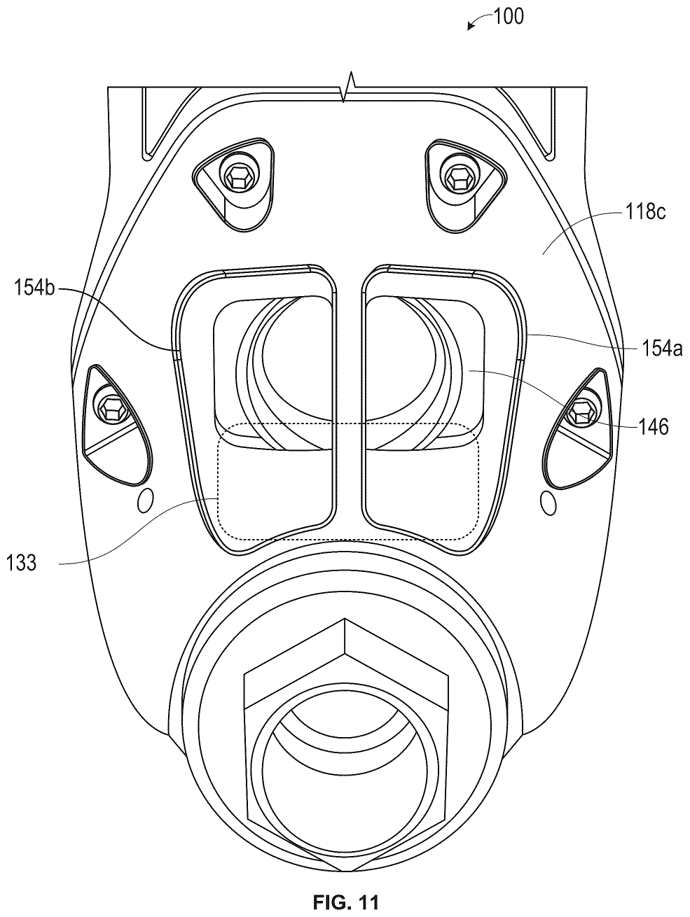

Referring to FIG. 9, a top view of the inflation device 100 shows the display 124 aligned with the opening 120 of the housing part 118a. Additionally, the housing part 118c includes an opening 154a and an opening 154b that may allow ambient air into the inflation device 100. Each of the openings 154a and 154b may be referred to as an inlet (e.g., air inlet) for ambient air. Thus, the openings 154a and 154b may represent a pair of inlets. Referring to FIG. 10, the button 110 is connected to the housing part 118b by a hinge 160 that allows the button 110 to move relative to the housing part 118b.

Referring to FIGS. 3 and 4, the opening 120 is formed through a surface 158a of the body 102, with the surface 158a defined by the housing part 118a. Further, the button 110 is connected to the body 102 at a surface 158b defined by the housing part 118b. When comparing the surfaces, the surface 158a is opposite the surface 158b, or vice versa. Thus, the display 124 and the button 110 are located at opposite surfaces of the body 102, and further, may be characterized as being at opposite ends or opposite locations of the inflation device 100.

Referring to FIG. 11, the flap 133 is not covering the opening 154a and the opening 154b of the housing part 118c. The flap 133 may be connected to the body 102 by a hinge (not shown in FIG. 11), with the hinge allowing for independent or simultaneous movement of the flap 133. When no other forces other than gravity act upon the flap 133, the flap 133 is in an open position (as shown in FIG. 11), thus allowing airflow (e.g., ambient air) in through the openings 154a and 154b, respectively. However, when the inflation device 100 experiences backflow, the flap 133 may close the openings 154a and 154b thus preventing airflow from exiting the inflation device 100 through the openings 154a and 154b.

Also, each of the openings 154a and 154b may be referred to as a chamfered opening. In this regard, the area (e.g., cross sectional area) of the openings 154a and 154b reduces, thus tapers. This may facilitate airflow by funneling airflow into the inflation device 100. Additionally, the openings 154a and 154b are aligned, or at least partially aligned, with the opening 146 (of the chamber 138 shown in FIG. 4). Beneficially, airflow passing through the openings 154a and 154b is generally unobstructed.

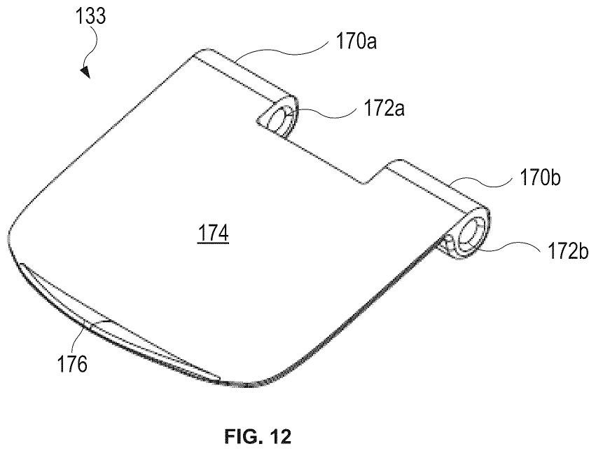

Referring to FIG. 12, a perspective view of the flap 133 is shown. The flap 133 may include a cylinder 170a and a cylinder 170b. The cylinder 170a and the cylinder 170b may include an opening 172a and an opening 172b, respectively. The openings 172a and 172b are designed to receive a cylindrical element (not shown in FIG. 12) used to couple (e.g., rotationally couple) the flap 133 to the housing part 118c shown in FIG. 2.

The flap 133 may further include a surface 174 and the cylinders 170a and 170b may extend from the surface 174. The flap 133 may further include an airfoil 176 disposed on the surface 174. As shown, the airfoil 176 is a body (e.g., aerodynamic body) that extends from the surface 174. In one or more implementations, the airfoil 176 interacts with airflow passing through the inflation device 100 (shown in FIG. 1) causing aerodynamic lift of the flap 133. For example, based in part on the airfoil 176, the flap 133 may transition from the position shown in FIG. 5 to the position shown in FIG. 6.

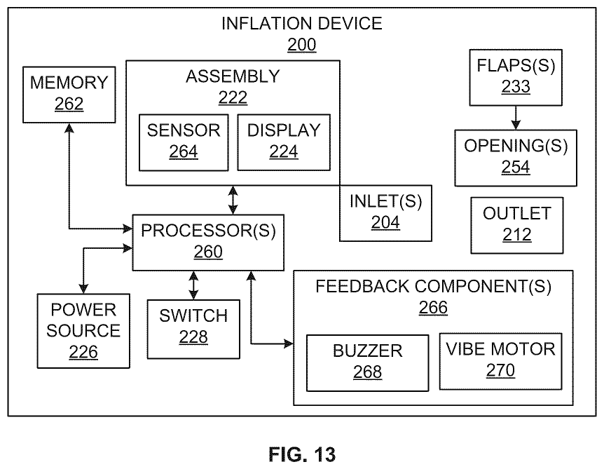

Referring to FIG. 13, a schematic diagram of an inflation device 200 is shown. The inflation device 200 may include any features shown and described herein for an inflation device. As shown, the inflation device 200 includes one or more processors 260. The one or more processors 260 may include processing circuitry that takes the form of a central processing unit, one or more microcontrollers, one or more micro electromechanical system (MEMS) controllers, or a combination thereof, as non-limiting examples. The inflation device 200 further includes memory 262. The memory 262 may include read-only memory (ROM), random access memory (RAM), or a combination thereof. The memory 262 may store instructions that are executable by the one or more processors 260. Exemplary instructions executable by the one or more processors 260 may include operating instructions of an assembly 222, which may include a sensor 264, and a display 224 of the inflation device 200. Additional exemplary instructions executable by the one or more processors 260 may include operating instructions when a signal is received from an activator 228 of the inflation device 200.

The inflation device 200 may further include a power source 226 coupled (e.g., electrically coupled) to the one or more processors 260. As a non-limiting example, the power source 226 may include one or more batteries that provide DC to the one or more processors 260 and the assembly 222.

When the activator 228 is closed, an input (e.g., electrical signal) may be provided to the one or more processors 260. The input to the one or more processors 260 may activate the components of the inflation device 200. For example, the one or more processors 260 can activate the assembly 222 and instruct the sensor 264 to measure pressure (e.g., air pressure) of an object (not shown in FIG. 12) being inflated by the inflation device 200. In some examples, the sensor 264 includes a piezoelectric element or a strain gauge. Still further, the one or more processors 260 can activate the display 224 and instruct the display 224 to present visual information, such as a numerical value (e.g., corresponding to a pressure reading) as measured by the sensor 264. The display 224 may also present, as visual information, the units of measure pressure. In some examples, the display 224 includes a liquid crystal display (LCD) or a light emitting diode (LED) display, as non-limiting examples. Further, when the activator 228 is opened (e.g., by releasing the button 110), the one or more processors 260 may initiate a power down sequence that shuts down all electronic-based devices after a predetermined time (e.g., approximately in the range of 10-15 seconds).

The inflation device 200 may further include several components that function mechanically without electronic components or other electrically controlled devices. For example, the inflation device 200 may include one or more flaps 233 flaps 233 that regulate airflow (e.g., ambient air) into the inflation device 200 through one or more openings 254 openings 254. In one or more implementations, the one or more flaps 233 are open. As a result, both airflow (e.g., compressed air) from one or more inlets 204 of the inflation device 200 and airflow (e.g., ambient air) from the one or more openings 254 may combine and pass through an outlet 212 of the inflation device 200, with the received airflow from the outlet 212 being used to inflate an object. Subsequently, the one or more flaps 233 may be closed when backflow enters the inflation device 200 from the object, causing the one or more flaps 233 to cover a respective opening of the one or more openings 254.

Additionally, the inflation device 200 may include one or more feedback components 266 operatively coupled to the one or more processors 260. For example, the one or more feedback components 266 may include a buzzer 268 designed to provide an audible sound in response to a threshold pressure as determined by the sensor 264. Alternatively or in combination, the one or more feedback components 266 may include a vibration motor 270 (“vibe motor”) designed to vibrate the inflation device 200 in response to a threshold pressure as determined by the sensor 264. Accordingly, the one or more feedback components 266 may provide a notification or indication of a current inflation of an object (e.g., bag being inflated). Beneficially, the one or more feedback components 266 provide users of the inflation device 200 with a manner to determine when an object being inflated is at or near completion of inflation. Moreover, the one or more feedback components 266 may be tuned or set to particular objects. For example, objects (e.g., bags) of different sizes may take a longer or shorter time interval to inflate. By tuning the one or more feedback components 266 to the type of bag, the feedback provided by the one or more feedback components 266 may be more accurate.

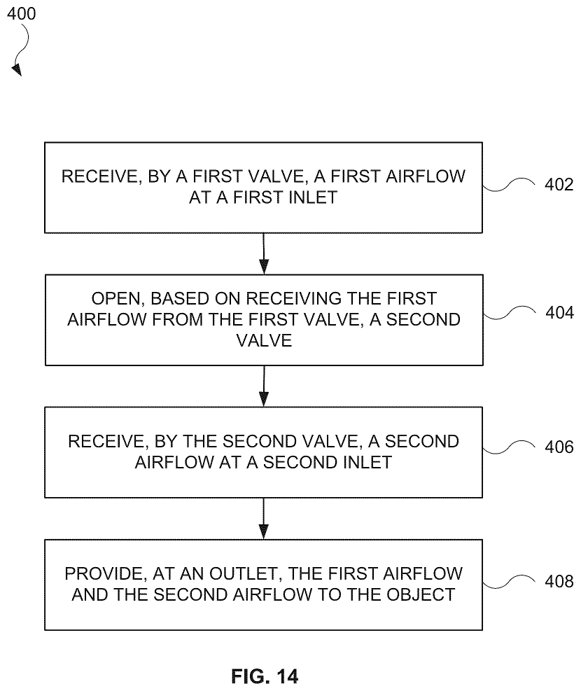

Referring to FIG. 14, a flowchart 400 showing a method for inflating an object is shown. The steps of the flowchart 400 may be performed inflation devices shown and/or described herein.

At step 402, a first airflow is received, by a first valve, at a first inlet. The first airflow may be provided by an air supply, such as an air compressor (as a non-limiting example). The first valve of the inflation device may include an electronically controlled valve that is operated by a button of the inflation device.

At step 404, a second valve is opened based on receiving the first airflow from the first valve. The first airflow may create a force that causes the second valve of the inflation device to open. For example, the inflation device may include a channel that reduces in volume, or size, causing the first airflow to increase in speed based on a Venturi effect. The increased speed by the first airflow may provide a force that causes the second valve to open.

At step 406, a second airflow is received, by the second valve, at a second inlet. In some examples, the second airflow is separate from the first airflow. For example, the second airflow may include ambient air that is drawn into the second inlet when the second valve is open.

At step 408, the first airflow and the second airflow are provided, at an outlet, to the object. The outlet of the inflation device may be connected to a hose that acts as a conduit to provide the first airflow and the second airflow to inflate the object. In some examples, airflow is provided back to the inflation device from the object, causing the second valve to close and stopping the second airflow from entering the second inlet of the inflation device.

In one or more aspects of the present disclosure, an inflation device is described. The inflation device may include a first inlet configured to receive a first airflow. The inflation device may further include a valve configured to regulate the first airflow through the first inlet. The inflation device may further include a second inlet configured to receive a second airflow separate from the first airflow. The inflation device may further include a flap configured to regulate the second airflow through the second inlet. The inflation device may further include a button. In one or more implementations, in response to actuation of the button, the valve opens and the first airflow is received through the first inlet, thereby causing the second airflow to enter through the second inlet. The inflation device may further include a regulating device. The regulating device may include a chamber that includes i) a first opening having a first diameter and ii) a second opening comprising a second diameter greater than the first diameter. The regulating device may further include a seal that surrounds the chamber.

In one or more aspects of the present disclosure, an inflation device is described. The inflation device may include a body. The inflation device may further include a first pair of inlets configured to receive a first airflow. The inflation device may further include a valve configured to regulate the first airflow into the body through the first pair of inlets. The inflation device may further include a second pair of inlets configured to receive a second airflow separate from the first airflow. The inflation device may further include a flap configured to control the second airflow through the second pair of inlets The inflation device may further include an outlet. In one or more implementations, the first airflow and the second airflow exit the body through the outlet, in response to backflow into the outlet, the flap closes the second pair of inlets.

In one or more aspects of the present disclosure, a method is described. The method may include receiving, by a valve of an inflation device, a first airflow at a first inlet. The method may further include receiving, based on receiving the first airflow from the valve, a second airflow at a second inlet. The second airflow may be separate from the first airflow. The method may include providing, at an outlet, the first airflow and the second airflow to the object. The method may include in response to receiving backflow through the outlet, closing, by a flap, the second inlet to block the second airflow.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An inflation device, comprising:
a first inlet configured to receive a first airflow;
a valve configured to regulate the first airflow through the first inlet;
a second inlet configured to receive a second airflow separate from the first airflow;
a flap configured to regulate the second airflow through the second inlet; and
a button, wherein in response to actuation of the button, the valve opens and the first airflow is received through the first inlet, thereby causing the second airflow to enter through the second inlet; and
a regulating device, the regulating device comprising:
a chamber comprising i) a first opening having a first diameter and ii) a second opening comprising a second diameter greater than the first diameter; and
a seal that surrounds the chamber.

2. The inflation device of claim 1, further comprising:
a sensor configured to determine a pressure based on the first airflow and the second airflow provided to an object; and
a display configured to present the pressure as visual information.

3. The inflation device of claim 2, further comprising a power source, wherein in response to the actuation of a button, the power source provides electrical energy to the sensor and the display.

4. The inflation device of claim 3, wherein the valve opens in response to the actuation of the button.

5. The inflation device of claim 4, wherein the display powers down at a predetermined time in response the button no longer being actuated.

6. The inflation device of claim 1, wherein:
the chamber comprises a plastic; and
the seal comprises rubber.

7. The inflation device of claim 1, wherein the first opening comprises:
a first portion; and
a second portion angled with respect to the first portion.

8. The inflation device of claim 1, wherein the first inlet configured to receive the first airflow via an air compressor.

9. The inflation device of claim 1, wherein the second inlet configured to receive the second airflow via ambient air.

10. An inflation device, comprising:
a body;
a first pair of inlets configured to receive a first airflow;
a valve configured to regulate the first airflow into the body through the first pair of inlets;
a second pair of inlets configured to receive a second airflow separate from the first airflow;
a flap configured to control the second airflow through the second pair of inlets; and
an outlet, wherein:
the first airflow and the second airflow exit the body through the outlet,
in response to backflow into the outlet, the flap closes the second pair of inlets.

11. The inflation device of claim 10, further comprising:
a display aligned with an opening through a first surface of the body; and
a button connected to the body at a second surface of the body, the second surface opposite the first surface.

12. The inflation device of claim 11, further comprising:
a switch; and
a power supply, wherein in response to the button actuating the switch, the power supply provides electrical energy to the display.

13. The inflation device of claim 10, further comprising a regulating device, the regulating device comprising:
a chamber; and
a seal that surrounds the chamber.

14. The inflation device of claim 13, wherein the chamber comprises:
a first opening comprising a first diameter; and
a second opening comprising a second diameter greater than the first diameter.

15. The inflation device of claim 10, wherein the first pair of inlets are configured to receive the first airflow via an air compressor.

16. The inflation device of claim 10, wherein the second pair of inlets are configured to receive the second airflow via ambient air.

17. The inflation device of claim 10, wherein:
the outlet is configured to provide the first airflow and the second airflow to an object, and
in response to inflation of the object based on the first airflow and the second airflow, the outlet is configured to receive the backflow from the object.

18. A method for inflating an object, the method comprising:
receiving, by a valve of an inflation device, a first airflow at a first inlet;
receiving, based on receiving the first airflow from the valve, a second airflow at a second inlet, wherein the second airflow is separate from the first airflow;
providing, at an outlet, the first airflow and the second airflow to the object; and
in response to receiving backflow through the outlet, closing, by a flap, the second inlet to block the second airflow.

19. The method of claim 18, further comprising providing, based one or more feedback components, a notification based on a current inflation of the object.

20. The method of claim 18, wherein:
the first inlet configured to receive the first airflow via an air compressor, and
the second inlet configured to receive the second airflow via ambient air.
